(19) United States
(12) Patent Application Publication
(10) Pub. No.: US 2003/0019653 A1
(43) Pub. Date: Jan. 30, 2003

(54) Intermetallic contact surface structure and connector

(75) Inventors: Nobuhiro Kuga, Atsugi City (JP); Syuhei Ishikawa, Nagoya City (JP); Yoshiki Ishibashi, Nagoya City (JP)

Correspondence Address: BURR & BROWN, PO BOX 7068, SYRACUSE, NY, 13261-7068, US

(73) Assignee: NGK Insulators, Ltd., Nagoya City (JP)

(21) Appl. No.: 10/132,683

(22) Filed: Apr. 25, 2002

(30) Foreign Application Priority Data
Jul. 23, 2001 (JP) 2001-221,147

(51) Int. Cl. H01B 1/00

(52) U.S. Cl. 174/68.1

(57) ABSTRACT

A contact surface structure including furring layers made of non-magnetic nickel formed by an electroless plating of nickel and gold plating layers applied on the furring layers is provided on contact surfaces of male and female metal members constituting a central conductor of coaxial connector. A coaxial connector having an intermodulation distortion suppressed effectively, a high mechanical strength, a high ruggedness, and can be manufactured at a low cost is realized by providing an intermetallic contact surface structure.

### BACKGROUND OF THE INVENTION

1. Field of the Invention

The present invention relates to a contact surface structure between metallic substances, and more particularly to an intermetallic contact surface structure in which intermodulation distortion generated at an intermetallic contact site can be suppressed. The present invention also relates to a connector, particularly a coaxial connector having such an intermetallic contact surface structure.

2. Related Art Statements

In various kinds of communication systems, there is a problem of intermodulation distortion due to an interference between two signals having different frequencies. For instance, an antenna system provided in a base station of a mobile communication is commonly used for transmission and reception. Since a transmission frequency differs from a reception frequency, a problem of intermodulation distortion occurs therebtween. Noise due to the intermodulation distortion interferes a receiving frequency band, and sometimes communication might be impossible. In the mobile communication system, various studies have been performed for suppressing the intermodulation distortion generated in active circuits such as amplifires, and substantial effect have been attained. However, no effective measure has been taken for intermodulation distortion generated at passive portions, i.e. intermetallic contact surfaces such as connector, antenna and portions surrounding antenna, e.g. antenna fittings.

FIG. 1 is a schematic view showing portions surrounding an antenna of a base station of mobile communication system at which intermodulation distortion might be generated. A transmission antenna 12 and a reception antenna 13 are provided on a tower 11 of a base station. Each of these antennas comprise an antenna element array 14 having a number of antenna elements. The antenna elements are connected to antenna input/output terminal 16 by means of a beam control device 15 for directing an antenna beam into a desired direction. FIG. 2 illustrates an embodiment of the antenna element array 14, in which an antenna element is formed by a print dipole antenna. On a print circuit board 17 there are formed antenna elements 18 in accordance with a give pattern, and a reflecting plate 19 is provided perpendicularly to the print circuit board 17. The print circuit board 17 and reflecting plate 19 are installed within a cylindrical cover 20. In such an antenna structure, intermodulation distortion might occur at various portions such as a contact point between a power feeding circuit for the antenna element array 14 and the beam control device 15, conductor connecting portions within the beam control device 15, a contact site between the antenna input/output terminal 16 and a coaxial cable, fittings for securing the antennas 12, 13 to the tower 11 and a contact site between the print circuit board 17 and the cover 20.

Upon studying the generation of the intermodulation distortion at various sites surrounding the antenna of the base station of the mobile communication system, it has been found that the sites include a contact surface between metal materials. Heretofore, the intermodulation distortion generated at such an intermetallic contact surface has not occurred a large problem, but in accordance with a high frequency and a weak signal field, the intermodulation distortion due to a non-linearity of such an intermetallic contact surface would introduce a problem.

Particularly, in a base station of cellular phone or mobile phone system, an antenna is commonly used for the transmission and reception and a plurality of antennas are provided with a short distance, the above mentioned intermetallic distortion generated at an intermetallic contact surface might cause a serious problem. At the cellular phone base station, a reception power is lower than a transmission power and an electric field of a received signal is liable to be very weak and an influence of the intermodulation distortion becomes relatively large. If the intermodulation distortion enters in a reception frequency band, a signal could not be received any more.

In order to suppressing the above mentioned intermodulation distortion generated at the intermetallic contact surface, it is first be considered to remove the intermetallic contact surface. However, this solution is not practical, because it is difficult to construct a base station of the cellular phone system without providing the intermetallic contact surface. Moreover, the intermodulation distortion might occur at a contact surface between metal materials of the same kind due to a difference in surface condition. Therefore, even if conductors are made of the same metal material, the intermodulation distortion could not be removed.

In a second solution, the intermodulation distortion could be suppressed by reducing a current density by increasing a contact surface area and a contact pressure. However, a base station has been desired to be small in size and light in weight, and therefore an contact surface area could not be increased. Therefore this could not be a practical solution. For instance, a connection to a coaxial cable is performed by means of a coaxial connector. DIN connectors have been widely used, because they generate a small amount of the intermodulation distortion. However, the existing DIN connectors are large in size and it has been desired to reduce a size. Therefore, a contact surface area of the DIN connectors could not be reduced.

In a third solution, the intermodulation distortion is suppressed by improving a contact condition of the intermetallic contact surface structure. For instance, the generation of intermodulation distortion may be suppressed effectively without making a contact surface area and contact pressure excessively large by optimizing a substrate metal, electroplating material and surface roughness.

In many base stations of the cellular phone system, various members are connected by means of coaxial cables and coaxial connectors. 7/16 DIN connectors and 4.1/9.5 DIN connectors having superior properties have been widely used.

The DIN connector is larger than N connector which has been generally used in various applications, and a contact surface area and a contact pressure can be increased. Therefore, the generation of the intermodulation distortion is suppressed. However, in the recent cellular phone system, the power has been further reduced, and therefore the influence of the intermodulation distortion would be much more increased. Therefore, it has been desired to develop a new coaxial connector in which the generation of the intermodulation distortion is further reduced.

In the coaxial connector, various solutions nave been proposed for decreasing a contact resistance between metal substances, increasing a mechanical strength and improving a ruggedness. For instance, it has been proposed to provide a plating layer on an intermetallic contact surface for improving a corrosion resistance as well as for reducing a contact resistance. In a typical known intermetallic contact surface structure, a nickel plating layer is provided as a furring layer, and a gold plating layer is provided on the nickel furring layer. Such an intermetallic contact surface structure has a superior property in the contact resistance, mechanical strength and corrosion resistance. However, the generation of the intermodulation distortion could not be sufficiently suppressed. Particularly, the nickel plating layer serving as the furring layer is magnetic material which is liable to generate the intermodulation distortion. It has been known to use a silver plating layer for suppressing the intermodulation distortion, but the silver plating layer has a low corrosion resistance as well as a high contact resistance. Moreover, the silver plating layer is relatively soft and might be pealed off during the inserting and pulling out operation under a high contact pressure.

### SUMMARY OF THE INVENTION

The present invention has for its object to provide an intermetallic contact surface structure which has a low contact resistance, a high mechanical strength, a high ruggedness and can suppress the intermodulation distortion, and to provide a connector which includes such an improved intermetallic contact surface structure and can be manufactured at a low cost.

According to the invention, an intermetallic contact surface structure comprises first and second metal members which are electrically connected to each other, and a plating film including at least non-magnetic nickel plating layers provided on contact surfaces of said first and second metal members to suppress an intermodulation distortion. In the intermetallic contact surface structure according to the invention, it is preferable that said plating film includes furring layers made of non-magnetic nickel applied on contact surfaces of the first and second metal members and gold plating layers applied on said furring layers for improving corrosion resistance.

According to the invention, a connector comprises first and second metal members electrically connected to each other, and an intermetallic contact surface structure including furring layers of non-magnetic nickel applied on contact surfaces of said first and second metal members and gold plating layers applied on said furring layers.

In the intermetallic contact surface structure and connector according to the invention, said furring layer of non-magnetic nickel is preferably formed by the electroless plating of nickel. Furthermore, the connector according to the invention is preferably formed as a coaxial connector, particularly DIN type or SMA type connector.

### BRIEF DESCRIPTION OF THE DRAWINGS

FIG. 1 is a schematic view showing intermodulation distortion generating sites in a base station of a mobile communication system;

FIG. 2 is a schematic view representing intermodulation distortion generating sites in an antenna;

FIG. 3 is a block diagram illustrating a whole structure of an intermodulation distortion measuring system developed by the inventors of the present application;

FIG. 4 is a perspective view showing a detailed structure of a flat contact element;

FIG. 5 is a perspective view representing a detailed structure of a non-contact connector;

FIG. 6 is a graph representing a property of the non-contact connector;

FIG. 7 is a cross sectional view showing schematically a flat contact element for investigating a property of a known coaxial connector;

FIG. 8 is graph denoting an intermodulation distortion property of a known connector having a gold plating layer applied on a furring layer of nickel;

FIG. 9 is a graph representing an intermodulation distortion property of a known connector having a gold plating layer applied on a furring layer of nickel;

FIG. 10 is a graph expressing an intermodulation distortion property of a known connector having a silver plating layer;

FIG. 11 is a graph showing an intermodulation distortion property of a comparable connector having a platinum plating layer;

FIG. 12 is a graph representing an intermodulation distortion property of a comparable connector having a tin plating layer;

FIG. 13 is a cross sectional view illustrating schematically a flat contact element for use in study of the intermodulation distortion property of the intermetallic contact surface structure according to the invention, in which a golf plating layer is formed on a non-magnetic furring layer formed by the electroless plating;

FIG. 14 is a graph representing the intermodulation distortion property of the intermetallic contact surface structure according to the invention;

FIG. 15 is a graph denoting the intermodulation distortion property of the intermetallic contact surface structure according to the invention; and

FIG. 16 is a cross sectional view showing an embodiment of the connector according to the invention formed as DIN connector.

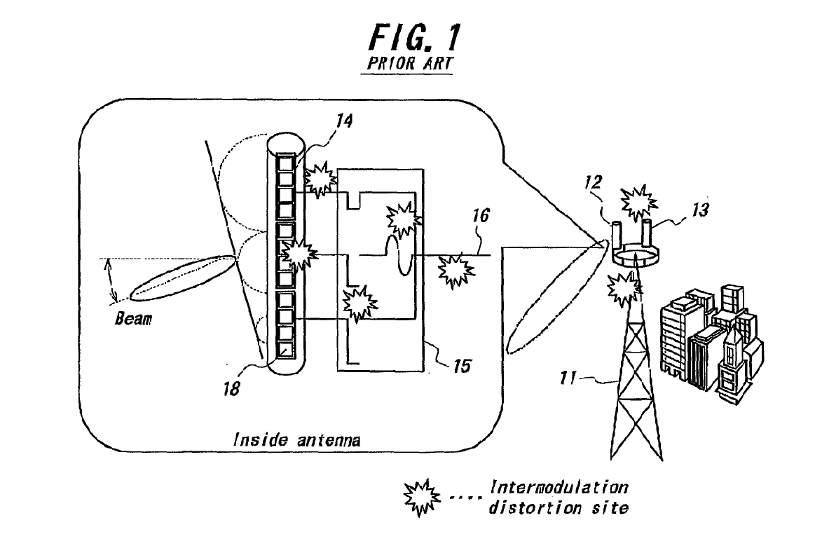

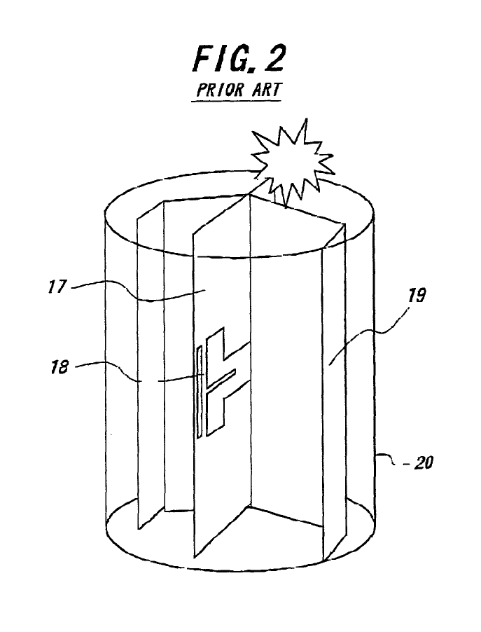

### DESCRIPTION OF THE PREFERRED EMBODIMENTS

According to the invention, the intermodulation distortion can be successfully suppressed by providing the non-magnetic nickel furring layers on the contact surfaces of metal members to be electrically connected to each other and by applying the gold plating layers on the furring layers. In order to find such a structure, it is necessary to manufacture a number of coaxial connectors while various parameters such as kinds of materials of furring layer, kinds of materials of plating layers, thicknesses of layers and surface conditions are changed in many ways and to measure intermodulation distortions of these connectors. It would require a lot of labor works, time an cost. Moreover, due to indefinite factors such as variations in processing the coaxial connectors and degradations in properties due to inserting and removing operations of the coaxial connectors, the intermodulation distortions might not be measured accurately.

Furthermore, in case of using the coaxial connector, it is necessary to connect the connector to a coaxial cable by means of soldering. This soldering operation is cumbersome. It is quite difficult to keep the soldering conditions of respective connectors constant, and the generation of the intermodulation distortion at the soldering sites might influence largely the measurement. This results in that the intermodulation distortion generated at the contact sites of the connectors could not be measured precisely.

The inventors of the present application have developed a novel intermodulation distortion measuring system which can measure an intermodulation distortion generated at a contact site of metal members accurately within a short time with a low cost and low labor work, and the conception of the present invention has been attained by utilizing this intermodulation distortion measuring system. Now the intermodulation distortion measuring system will be first explained prior to concrete explanation of the invention.

In the intermodulation distortion measuring system developed by the inventors, a plurality of flat contact elements are prepared. Each of the flat contact element comprises a dielectric substrate having flat surfaces and a conductor pattern applied on one of said flat surfaces and including a contact conductor portion, a connection conductor portion and an intermediate conductor portion, and a base plate applied on the other flat surface. A connection conductor portion of a first flat contact element is connected to a intermodulation distortion measuring circuit by means of a first non-contact connector, and a second flat contact element is stacked on the first flat contact element such that a contact conductor portion of the second flat contact element is brought into contact with a contact conductor portion of the first flat contact element. A connection conductor portion of the second flat contact element is connected to a dummy load by means of a second non-contact connector. An intermodulation distortion generated at a contact site of the contact conductor portions of the first and second flat contact element is measured.

In such an intermodulation distortion measuring system developed by the inventors, use are made of the flat contact elements having the conductor patterns made of metals to be tested, and the flat contact elements can be manufactured using printed wiring boards. Therefore, labor work, time and cost for manufacturing test samples, i.e. flat contact elements can be extremely reduced, a variation in processing test samples can be decreased, and an accuracy of measurement of the intermodulation distortion can be improved due to a fact that a degradation of property due to mounting and displacing operation can be reduced. Furthermore, the flat contact elements can be connected to the intermodulation distortion measuring circuit and dummy load by means of the non-contact connectors, and thus it is no more necessary to use conventional soldering. Therefore, any measurement error due to a variation of soldering conditions is not introduced. In this manner, the intermodulation distortion can be measured very precisely.

The above mentioned non-contact connector comprises first and second dielectric substrates which are arranged parallelly and are separated from each other by a distance which is substantially equal to a thickness of the connection conductor portion of the flat contact element, and a third dielectric substrate which is sandwiched between the first and second dielectric substrates. On an outer surface of the first dielectric substrate, there is formed a conductor strip which is aligned with the connection conductor portion of the flat contact element when the flat contact element is inserted into a space between the first and second dielectric substrates such that a front end of the flat contact element is separated from a front edge of the third dielectric substrate by a given distance. A whole outer surface of the second dielectric substrate is covered with an electrically conductive film. On a surface of the third dielectric substrate opposing to the first dielectric substrate, there is formed a conductor strip which is aligned with the conductor strip formed on the outer surface of the first dielectric substrate. The opposite surface of the third dielectric substrate is covered with an electrically conductive film.

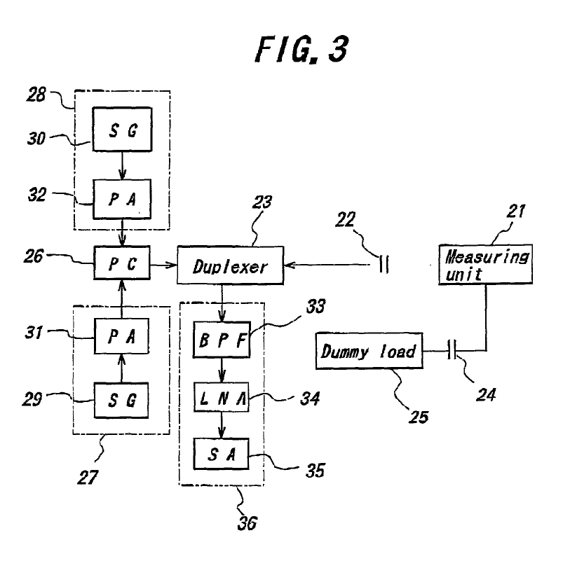

FIG. 3 is block diagram showing a whole construction of the intermodulation distortion measuring system developed by the inventors. A measuring unit 21 including first and second flat contact elements which constitute a contact site between metals is connected to a duplexer 23 by means of a first non-contact connector 22 as well as to a dummy load 25 by means of a second non-contact connector 24. In this embodiment, the dummy load 25 is formed by a semi-rigid coaxial cable having a length of 50 meters.

The duplexer 23 is connected to a power coupler 26, and the power coupler is connected to first and second wave sources 27 and 28. These first and second wave sources 27 and 28 are consisting of standard frequency generators 29, 30 of f₁ and f₂ and power amplifiers 31, 32. The duplexer 23 is further connected to an intermodulation distortion measuring circuit 36 including a band pass filter 33 for extracting an intermodulation distortion component, a low noise amplifier 34 and a spectrum analyzer 35.

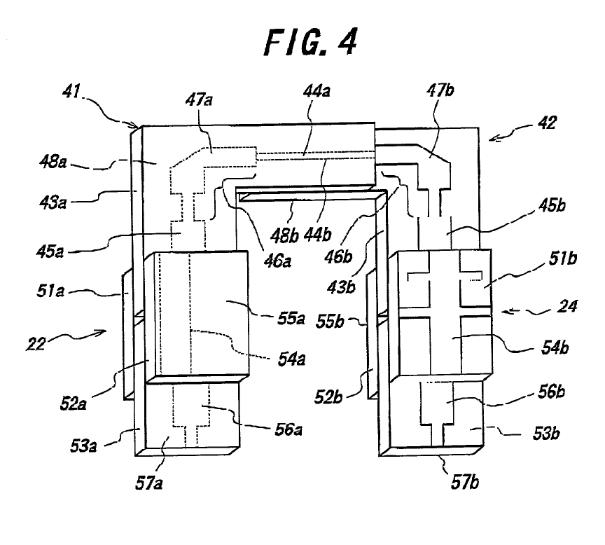

FIG. 4 is a perspective view illustrating a detailed construction of the measuring unit 21 including first and second flat contact elements, and the first and second non-contact connectors 22 and 24. Since first and second flat contact elements 41 and 42 have a substantially identical construction, only the first flat contact element 41 which is connected to the duplexer 23 by means of the first non-contact connector 22 will be explained. The first flat contact element 41 is formed by a printed wiring board. On one flat surface of a dielectric substrate 43a having a relative dielectric constant of, for example about 2.6, there are formed a contact conductor portion 44a, a connection conductor portion 45a and an intermediate conductor portion 46a connecting the contact conductor portion and connection conductor portion with each other. An opposite surface or the dielectric substrate 43a is covered with a base plate 47a formed by a metal film.

The second flat contact element 42 is formed in a manner explained above, and portions similar to those or the first flat contact element are denoted by the same reference numerals with suffix b. Upon measuring an intermodulation distortion, the first and second flat contact elements 41 and 42 are stacked such that the contact conductor portions 44a and 44b of these elements are brought into contact with each other with a given pressure. Then, the generation of the intermodulation distortion in accordance with surface conditions and contact pressure of the contact conductor portions can be investigated.

An intermetallic contact between metal substances is realized by contacting the first and second flat contact elements 41 and 42 each being formed by a flat printed wiring board with each other, and therefore it is no more necessary to prepare complicated coaxial connectors. A test sample formed by a flat printed wiring board can be manufactured easily within a short time. Moreover, a precision of manufacturing the test samples can be improved and an influence upon the accuracy of measuring the intermodulation distortion can be reduced, and the measurement can be performed accurately.

The first flat contact element 41 is connected to the duplexer 23, first and second wave sources 27 and 28 and the intermodulation distortion measuring circuit 36 by means of the first non-contact connector 22, and the second flat contact element 42 is connected to the dummy load 25 by means of the second non-contact connector 24. Therefore, the test samples can be connected to the intermodulation distortion measuring circuit and dummy load by a simple operation, and undesired intermodulation distortion is not generated at the connection sites.

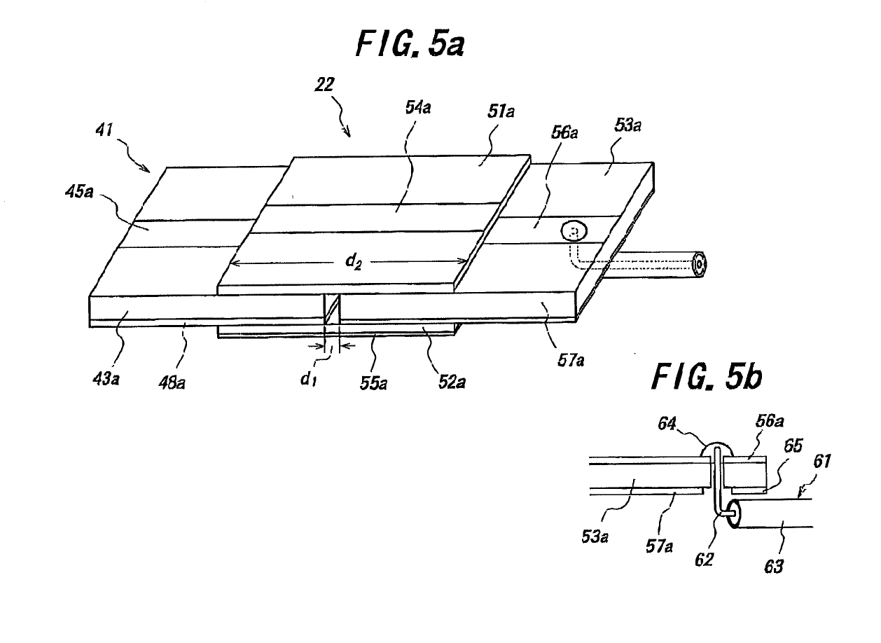

FIG. 5a is a perspective view showing a detailed construction of the first non-contact connector 22. It should be noted that the second non-contact connector 24 has a similar structure, and thus only the first non-contact connector 22 will be explained. The non-contact connector 22 comprises first and second dielectric substrates 51a and 52a which are arranged parallelly and are separated from each other by a distance which is substantially equal to a thickness of the end potion of the flat contact element 41 at which the connection conductor portion 45a is formed, and a third dielectric substrate 53a which is sandwiched between the first and second dielectric substrates 51a and 52a. The third flat dielectric substrate 53a is inserted such that a front end of the third dielectric substrate extends slightly before middle points of the first and second dielectric substrates 51a and 52a. These first to third dielectric substrates 51a, 52a and 53a may be made of a material having a relative dielectric constant of 2.0-3.0.

The flat contact element 41 is inserted into a space between the first and second dielectric substrates 51a and 52a of the non-contact connector 22 such that a front end of the flat contact element extends slightly before middle points of the first and second dielectric substrates. Therefore, when the flat contact element 41 is inserted, the front end of the flat contact element is separated from the front end of the third dielectric substrate 53a by a given distance. This distance d₁ may be, for instance about 1 mm. The first and second dielectric substrates 51a and 52a have a length d₂ of 156 mm.

On an outer surface of the first dielectric substrate 51a there is formed a conductor strip 54a which extends to be aligned with the connection conductor portion 45a of the flat contact element 41 when the flat contact element is inserted. A whole outer surface of the second dielectric substrate 52a is covered with an electrically conductive film 55a. On a surface of the third dielectric substrate 53a opposing to the first dielectric substrate 51a, there is formed a conductor strip 56a which is aligned with the conductor strip 54a formed on the outer surface of the first dielectric substrate 51a. The rear surface of the third dielectric substrate 53a is covered with an electrically conductive film 57a.

The first non-contact connector 22 is connected to the duplexer 23 by means of a coaxial cable. As shown in FIG. 5b, the conductor strip 56a formed on one surface of the third dielectric substrate 53a is connected to a core conductor 62 of a coaxial cable 61 by a soldering 64, and an outer conductor 63 of the coaxial cable 61 is connected to the electrically conductive film 57a formed on the other surface of the third dielectric substrate 53a. in this manner, a direct connection is existent between the non-contact connector 22 and the coaxial cable 61, and the flat contact elements 41, 42 may be exchanged without disconnecting said direct connection. Therefore, the measurement of intermodulation distortion is not affected by a condition of the connection. The second non-contact connector 24 has a similar structure as that explained above, and in FIG. 4, portions of the second non-contact connector similar to those of the first non-contact connector are denoted by the same reference numerals with suffix b.

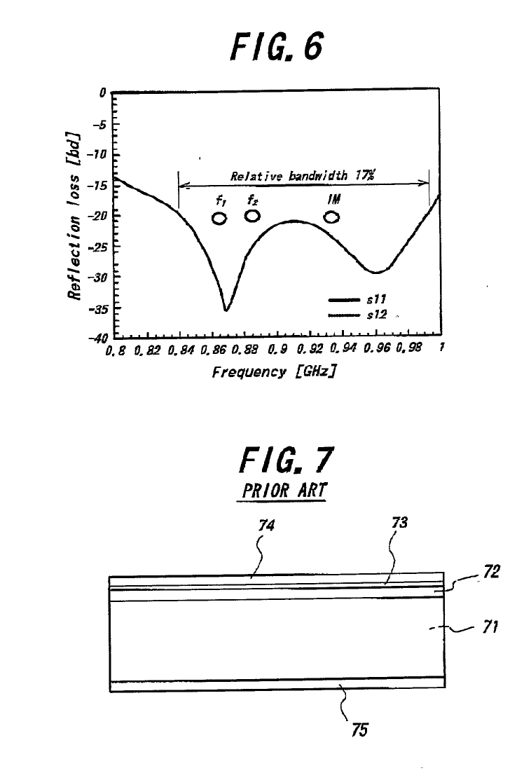

FIG. 6 represents an input property of the above explained non-contact connector 22. A reflection loss within a wide frequency band of relative bandwidth of 17% from 0.8 GHz to 0.99 GHz is not larger than −20 dB. Moreover, an insertion loss is not higher than 0.2 dB. Therefore, when the transmission frequency is set to 862 MHz and 887 MHz, a fifth order intermodulation distortion generating at 937 MHz can be effectively measured. It is also possible to measure other orders of intermodulation distortion such as third order and seventh order.

The inventors manufactured a very large number of flat contact elements using printed wiring boards, while kinds of metals of the contact conductor portions and surface conditions are changed in various ways. Two flat contact elements selected from these number of flat contact elements are stacked one on the other such that contact conductor portions of the stacked flat contact elements are brought into contact with each other, while a contact pressure is adjusted. These flat contact elements are connected to the intermodulation distortion measuring circuit 36 and dummy load 25 by inserting them into the spaces between the first and second dielectric substrates 51a and 52a of the non-contact connectors 22 and 24. In this manner, the measurement of intermodulation distortion is carried out.

In this case, since it is not necessary to connect the flat contact elements 41, 42 to the intermodulation distortion measuring circuit 36 and dummy load 25 by soldering, the connecting operation can be performed simply, and moreover a measuring error due to a variation in a soldering condition can be removed and the intermodulation distortion can be measured very accurately.

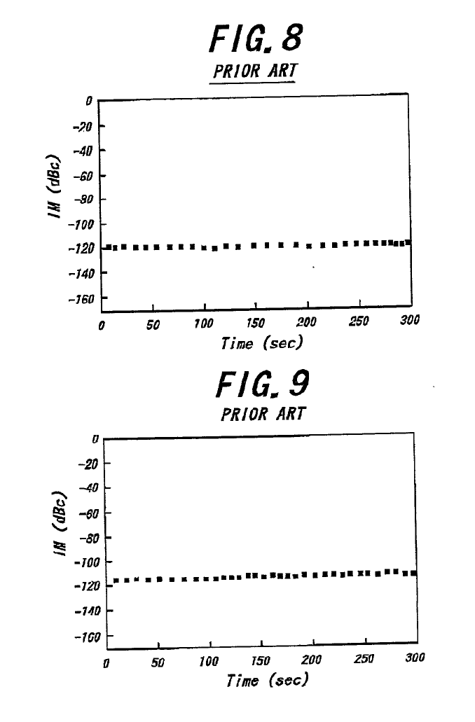

FIG. 7 shows schematically a flat contact element for investigating a property of a known DIN connector in which a gold plating layer is formed on a nickel furring layer. On a surface of a dielectric substrate 71 of a printed wiring board, an electrically conductive film 72 made of copper is formed with a thickness of 35 μm, a nickel furring layer 73 is formed with a thickness of 2 μm by electrolytic plating, and a gold plating layer 74 is formed with a thickness of 0.1 μm. On a rear surface of the dielectric substrate 71 there is formed an electrically conductive layer 75 of copper having a thickness of 35 μm. Four kinds of flat contact elements having the structure explained above were manufactured and the generation of intermodulation distortion was measured (this is identical for the following test). FIG. 8 is a graph representing a result of the measurement. In this graph, a horizontal axis denotes a time in second and a vertical axis represents the intermodulation distortion IM in dBc. In the known DIN connector, it has been found that a large intermodulation distortion of about −120 dBc is generated. FIG. 9 shows a measuring result of the intermodulation distortion for flat contact elements which have the same structure as that illustrated in FIG. 7, but a thickness of the gold plating layer is set to 0.05 μm. Also in this case, a large intermodulation distortion of about −115 dBc is generated.

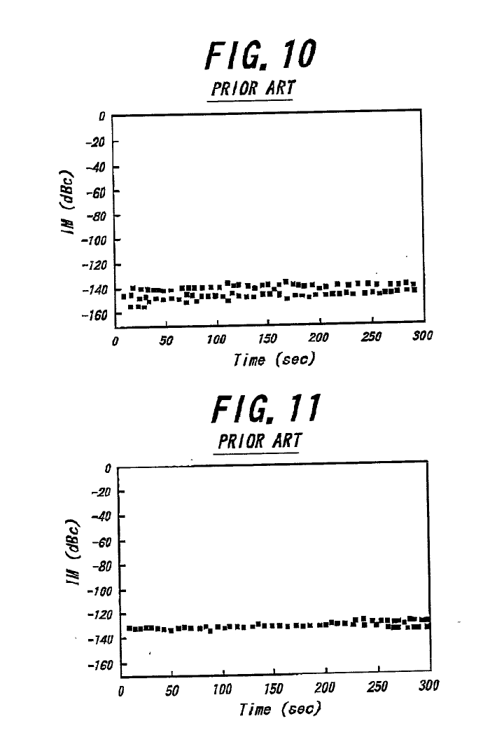

FIG. 10 depicts the generation of intermodulation distortion for flat contact elements, in which a silver plating layer is directly formed on a copper layer without interposing the furring layer. Such a structure is adopted in known coaxial connectors. In the coaxial connector, it has been well known to form a silver plating layer, but in this case, the generation of intermodulation distortion is not stable, and a contact is unstable. Furthermore, the silver plating layer has a weak mechanical strength, a low corrosion resistance and a high contact resistance due to oxidation.

FIG. 11 shows the generation of intermodulation distortion for flat contact elements, in which a plating layer of platinum is directly formed on the electrically conductive layer of copper without interposing the furring layer. In this case, the intermodulation distortion is suppressed to about −130 dBc. However, platinum is expensive and const of coaxial connector becomes very high.

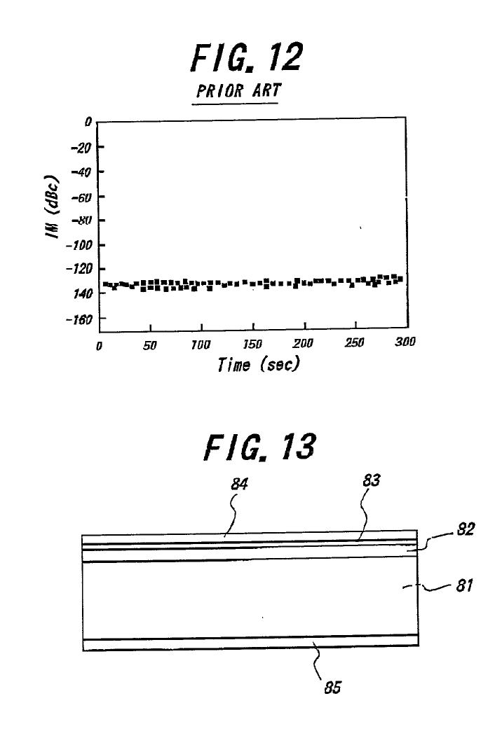

FIG. 12 represents the generation of intermodulation distortion for flat contact elements, in which a plating layer of tin is directly formed on the electrically conductive layer of copper without the furring layer. Also in this case, the intermodulation distortion is suppressed to about −130 dBc. However, the tin plating layer has a weak mechanical strength as well as a poor corrosion resistance. Therefore, the tin plating layer could not be utilized in an actual coaxial connector. Furthermore, the above mentioned plating layers of gold, platinum and tin might introduce a short-circuit due to whiskers and have low mechanical strength and corrosion resistance, and therefore it is practically difficult to attain a sufficiently high quality management.

FIG. 13 illustrates schematically the structure of a flat contact element for investigating a property of the intermetallic contact surface structure according to the invention. On a contact side surface of a dielectric substrate 81 formed by a printed wiring board, an electrically conductive layer 82 made of copper is formed with a thickness of 35 μm, a furring layer 83 of nickel is formed by the electroless plating with a thickness of 2 μm, and a gold plating layer 84 is formed with a thickness of 0.05 μm. On a rear surface of the dielectric substrate 81 there is formed an electrically conductive layer 85 made of copper with a thickness of 35 μm. A furring layer of nickel formed by the electrolytic plating like as a known coaxial connectors is a magnetic substance, but the furring layer 83 of nickel formed by the electroless plating is a non-magnetic substance. It has been known that the nickel plating layer formed by the electroless plating is a non-magnetic substance. The intermetallic contact surface structure according to the invention has been based on a fact that the generation of intermodulation distortion can be suppressed by providing the non-magnetic nickel plating layer. Furthermore, by providing the gold plating layer on the non-magnetic nickel furring layer formed by the electroless plating, the generation of intermodulation distortion can be further suppressed, and at the same time, the corrosion resistance and contact resistance can be improved.

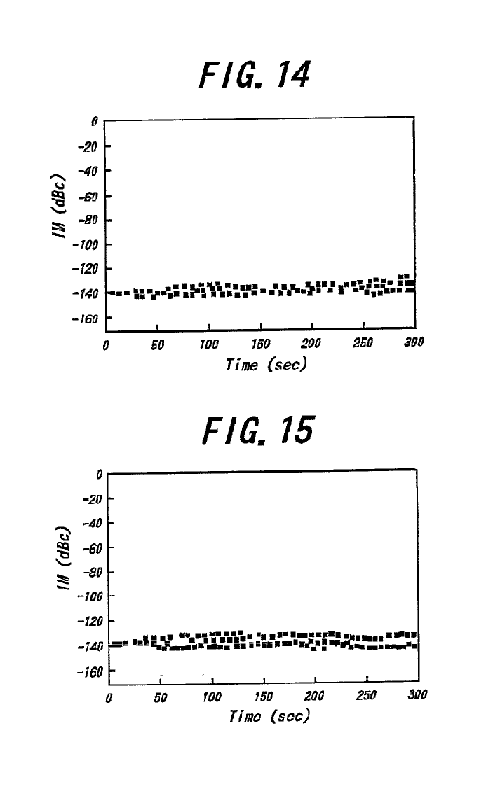

FIG. 14 shows the generation of intermodulation distortion when the flat contact elements illustrated in FIG. 13 simulating the intermetallic contact surface structure according to the invention are brought into contact with each other. In the intermetallic contact surface structure according to the invention, the intermodulation distortion is suppressed not larger than −130 dBc (about −14 dBc). Moreover, a fluctuation of the intermodulation distortion is small, and it is understood that a stable contact surface can be attained.

FIG. 15 represents the generation of intermodulation distortion when the flat contact elements for simulating the intermetallic contact surface structure according to the invention, in which a thickness of the gold plating layer is set to 0.03 μm as compared with the element shown in FIG. 13 are brought into contact with each other. In this case, a difference for four kinds of the flat contact elements is larger than a case shown in FIG. 14, but the generation of intermodulation distortion can be suppressed and a time fluctuation is also small.

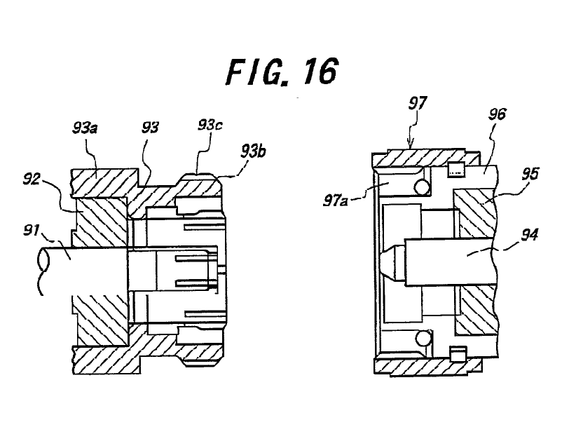

FIG. 16 depicts an embodiment of the coaxial connector having the intermetallic contact surface structure according to the invention. The connector of the present embodiment is constructed as DIN connector, in which various components are made of beryllium copper having excellent electrically conductivity and elasticity. A female connector shown on a left side includes a central conductor 91 which is formed by an electrically conductive cylindrical body having a diameter of 7 mm and a plurality of slits are formed in its tip. On a surface of the central conductor 91 there is formed a furring layer of non-magnetic nickel having a thickness of 1.5 μm, the furring layer being formed by the electroless plating. Furthermore, on the non-magnetic nickel furring layer there is formed a gold plating layer having a thickness of 0.05 μm. An electrically insulating disc 92 having the central conductor 91 at its center is fixed within an inner sleeve 93a of an outer conductor 93, and a screw 93c is formed in an outer surface of an outer sleeve 93b.

A male connector shown on a right hand side comprises a central conductor 94 formed by a cylindrical body whose tip portion has a diameter slightly smaller than 7 mm. Like as the central conductor 91 of the female connector, on the central conductor 94 there are formed a non-magnetic nickel furring layer of 1.5 μm by the electroless plating and a gold plating layer of 0.05 μm by the electrolytic plating.

An electrically insulating member 95 having the central conductor 94 of the male connector is fixed within an electrically conductive intermediate sleeve 96, and an outer sleeve 97 is provided rotatably around the intermediate sleeve. In an inner surface of a front portion of the outer sleeve 96 there is formed a thread 97a which is engaged with the screw 93c of the female connector. Therefore, by inserting the tip of the central conductor 94 of the male connector into the tip of the central conductor 91 of the female connector and by engaging the screw 93c with the thread 97a, the female connector and male connector can be coupled with each other. In this case, the above explained intermetallic contact surface structure is constituted at the contact site between the central conductors 91 and 94, and therefore a good contact condition can be attained and the generation of undesired intermodulation distortion can be effectively suppressed.

The present invention is not limited to the above explained embodiments, but many alternations and modifications may be conceived by a person skilled in the art within the scope of the invention. For instance, thicknesses of the furring layer of nickel and gold plating layer are not limited to those explained in the above embodiments, but may be modified at will. Moreover, in the above embodiment of the coaxial connector, metal components are made of beryllium copper, but they may be made of other metals. Furthermore, in the above embodiment, the coaxial connector is constructed as DIN connector, but it may be formed as other type coaxial connector such as SMA type connector and N connector. It should be further noted that the intermetallic contact surface structure according to the invention is not limited to the coaxial connector, but may be applied to any kind of contact sites of metals.

1. An intermetallic contact surface structure comprising first and second metal members which are electrically connected to each other, and a plating film including at least non-magnetic nickel plating layers provided on contact surfaces of said first and second metal members to suppress an intermodulation distortion.

2. The intermetallic contact surface structure according to claim 1, wherein said non-magnetic plating layer of the plating film is formed by an electroless plating layer of nickel.

3. The intermetallic contact surface structure according to claim 1, wherein said plating film including at least the non-magnetic nickel plating layers includes furring layers made of non-magnetic nickel applied on the contact surfaces of the first and second metal members and gold plating layers applied on said furring layers for improving a corrosion resistance.

4. The intermetallic contact surface structure according to claim 3, wherein said non-magnetic nickel plating layers of the plating film is formed by an electroless plating layer of nickel.

5. A connector comprising first and second metal members electrically connected to each other, and an intermetallic contact surface structure including furring layers of non-magnetic nickel applied on contact surfaces of said first and second metal members and gold plating layers applied on said furring layers.

6. The connector according to claim 5, wherein said first and second metal members are made of beryllium copper.

7. The connector according to claim 5, wherein said non-magnetic nickel plating layer of the plating film is formed by an electroless plating layer of nickel.

8. The connector according to claim 7, wherein said first and second metal members are made of beryllium copper.

9. The connector according to claim 5, wherein said connector is constructed as a coaxial connector.

10. The connector according to claim 9, wherein said coaxial connector is constructed as DIN connector.

11. The connector according to claim 9, wherein said coaxial connector is constructed as SMA type connector.
